(19) United States
(12) Patent Application Publication
(10) Pub. No.: US 2013/0160418 A1
(43) Pub. Date: Jun. 27, 2013

(54) Support for Reel or Auger with Single Piece Tube

(71) Applicants: Christopher T. Sauerwein, Newton, KS (US); Randy Lohrentz, Buhler, KS (US); Gagan Sethi, Hesston, KS (US)

(72) Inventors: Christopher T. Sauerwein, Newton, KS (US); Randy Lohrentz, Buhler, KS (US); Gagan Sethi, Hesston, KS (US)

(73) Assignee: AGCO Corporation, Duluth, GA (US)

(21) Appl. No.: 13/336,064

(22) Filed: Dec. 23, 2011

(51) Int. Cl. A01D 57/12

(52) U.S. Cl. 56/220

(57) ABSTRACT

A reel may be disclosed. The reel may comprise a bearing mount, a bearing, and a reel tube. The bearing mount may be connected to the bearing. The reel tube may comprise a midpoint. The reel tube may also be a continuous piece and may be supported proximate the midpoint by the bearing.

### CROSS-REFERENCE TO RELATED APPLICATIONS

The current application is related to U.S. patent application Ser. No. ______, filed on Dec. 23, 2011, entitled “Tine Adjustment for a Header,” (Attorney Docket No. A1206H), which is hereby incorporated by reference in its entirety.

### BACKGROUND

Equipment such as, for example, agricultural machines, may have a reel to direct crops into the agricultural machines. Traditionally, reels in excess of 20 ft. are manufactured from multiple sections. The multiple sections require connections along the reel. The connections are costly and require U-joints, connecting shafts, and connecting flanges.

### BRIEF DESCRIPTION OF THE DRAWINGS

The accompanying drawings, which are incorporated in and constitute a part of this disclosure, illustrate various embodiments of the disclosure. In the drawings:

FIG. 1 is a diagram of a combine;

FIG. 2 is a diagram of a header; and

FIG. 3 is a diagram of a reel.

### DETAILED DESCRIPTION

### Overview

A reel may be disclosed. The reel may comprise a bearing mount, a bearing, and a reel tube. The bearing mount may be connected to the bearing. The reel tube may comprise a midpoint. The reel tube may also be a continuous piece and may be supported proximate the midpoint by the bearing.

Both the foregoing overview and the following example embodiments are examples and explanatory only, and should not be considered to restrict the disclosure's scope, as described and claimed. Further, features and/or variations may be provided in addition to those set forth herein. For example, embodiments of the disclosure may be directed to various feature combinations and sub-combinations described in the detailed description.

### Example Embodiments

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

A header may be connected to a combine. The header may comprise a reel. The reel may be used to direct grain or other crops into the combine for harvesting. The reel may be constructed of a continuous material. The continuous material may or may not require support to keep the reel from deforming.

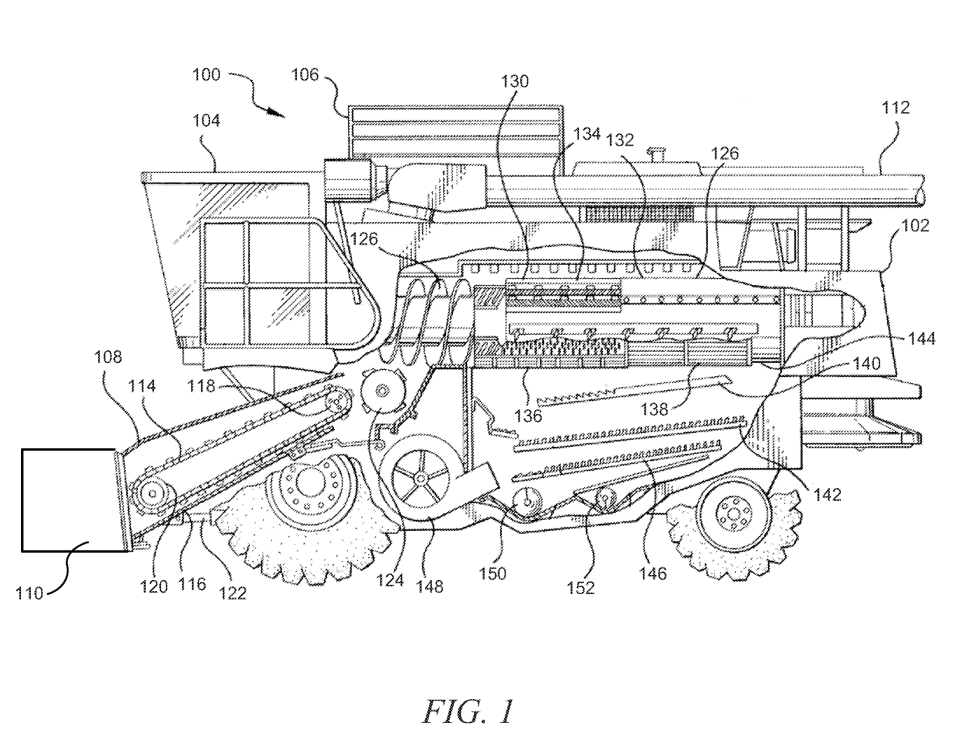

FIG. 1 is a diagram of a combine 100. Combine 100 may comprise a separator housing 102, an operator's work station and cab 104, a grain tank 106, an elevator assembly 108, and a header 110. A swingable unloading auger assembly 112 may pivot to a position extending laterally outward to one side of combine 100 to unload grain tank 106. Unloading auger assembly 112 may swing inward to a storage position as shown in FIG. 1 when grain tank 106 is not being unloaded.

Elevator assembly 108 may have a conveyor 114 mounted in an elevator housing 116. Conveyor 114 may be trained around rear drive sprockets 118 and a front drum 120. Hydraulic linear actuators 122 may pivot elevator housing 116 to raise and lower the forward end of elevator housing 116.

Crop material may be fed to a feed beater 124 by conveyor 114 in elevator housing 116. Feed beater 124 may feed crop material to a separating rotor 126. Separating rotor 126 may comprise a feed section 128, a threshing section 130, and a separation section 132. Feed section 128 may move crop material in a spiral path about a generally horizontal fore and aft axis of rotation to separating rotor 126, toward threshing section 130. In threshing section 130, crop material may pass between a cylinder bar 134 and a concave 136 where grain may be threshed. Threshed grain, that is not separated by concave 136, may be separated in separation section 132 and may pass through a separation grate 138. A grain pan 140 may convey grain and chaff forward and may deposit it on a chaffer 142. Crop material other than grain (MOG) may be discharged from separating rotor 126 through a rotor discharge 144.

Grain and MOG that may pass through concave 136 and separation grate 138 may fall to upper grain pan 140. Grain pan 140 may convey grain and chaff forward and may deposit it on chaffer 142. The grain may be cleaned by chaffer 142 and a sieve 146 and air from a fan assembly 148. Chaff may be discharged from the rear of sieve 146 and chaffer 142. Clean grain may fall into a clean grain auger 150. The clean grain may be conveyed to grain tank 106 by clean grain auger 150 and an elevator (not shown). Tailings may fall into a returns auger 152 and may be conveyed to separating rotor 126 by returns auger and return elevators (not shown), where they may be threshed a second time.

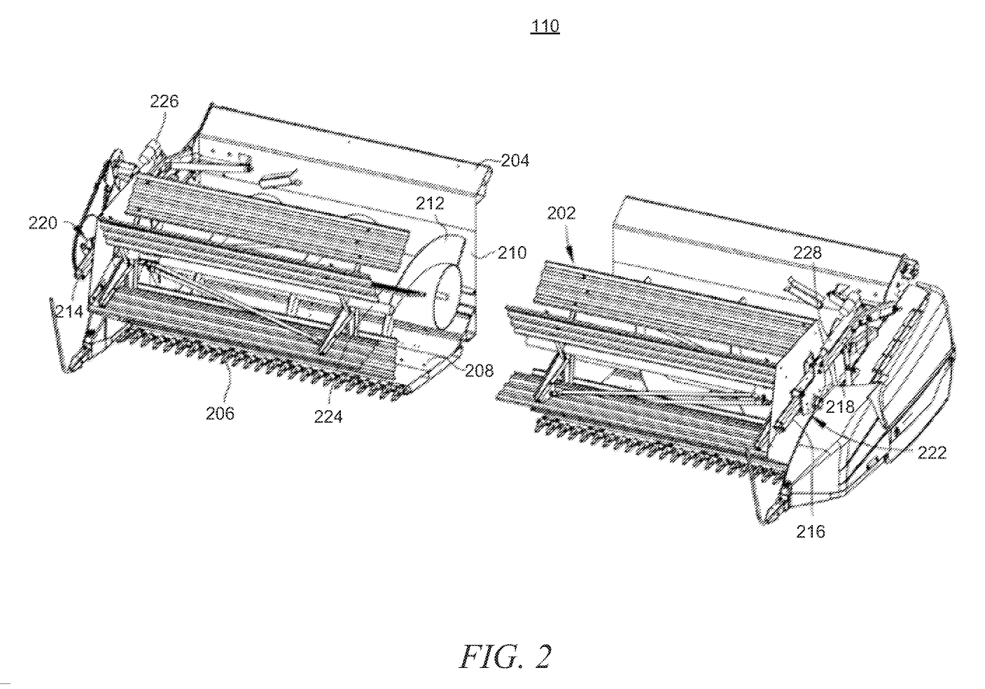

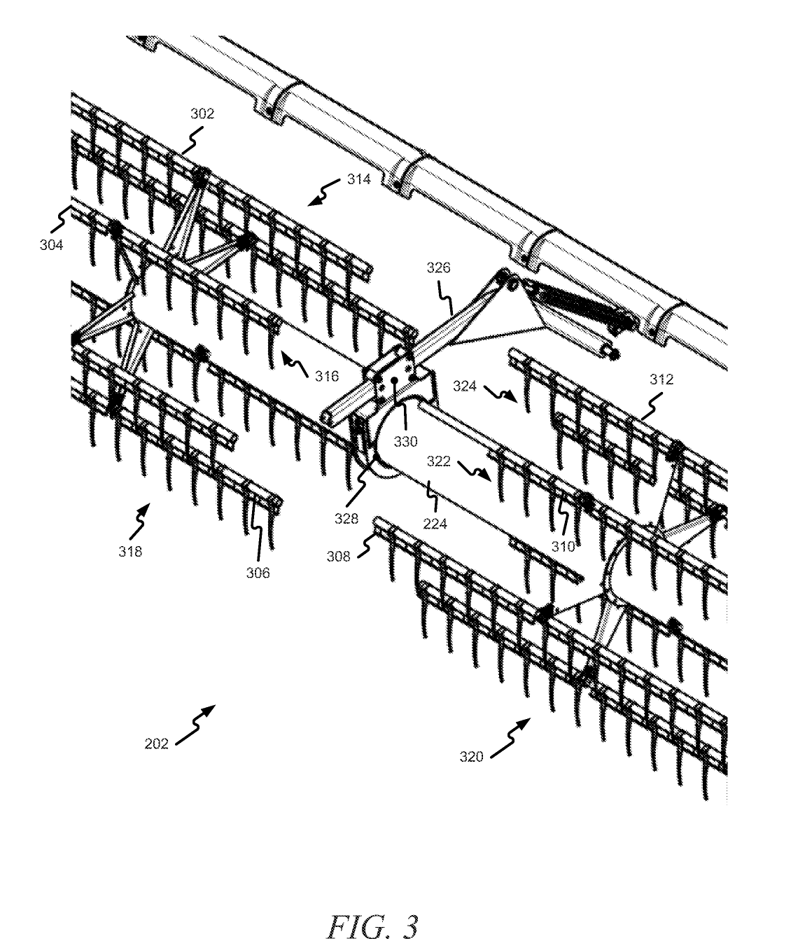

FIG. 2 shows header 110 comprising a reel 202. As shown in FIG. 2, header 110 may comprise a frame 204 supporting a sickle assembly 206 across the lower front of header 110. A pan 208 may extend rearwardly from sickle assembly 206 to a generally upright rear wall 210. A center-gathering auger 212 may be located above pan 208 and forwardly of rear wall 210. Center-gathering auger 212 may convey crop material toward the center of header 110 for discharge into elevator assembly 108 of combine 100. The center portion of reel 202 is shown in FIG. 3 and described below.

Reel 202 may be supported above pan 208 and in front of center-gathering auger 212 by a pair of elongated, fore-and-aft extending, laterally spaced apart first support arm 214 and second support arm 216 adjacent opposite ends of header 110. First arm 214 and second arm 216 may be pivotally mounted at their rear ends to frame 204 at pivots (not shown) to enable reel 202 to be adjustably raised and lowered relative to pan 208 and sickle assembly 206. Hydraulic cylinders may interconnect first arm 214 (a hydraulic cylinder 218) and second arm 216 (not shown) with frame 204 for effecting powered raising and lowering of first support arm 214 and second support arm 216 to adjust reel 202's height.

A first carrier assembly 220 and a second carrier assembly 222 may be provided on first arm 214 and second arm 216, respectively, for mounting opposite ends of reel 202 on first arm 214 and second arm 216 in a rotatable manner. First carrier assembly 220 may be adapted to support the drive for reel 202 while second carrier assembly 222 may have no such drive. In addition, first carrier assembly 220 and second carrier assembly 222 both may provide a driving force for reel 202. The driving force may be provided by second carrier assembly 222 instead of first carrier assembly 220.

First arm 214 and second arm 216 may have a first linear actuator 226 and second linear actuator 228, respectively. First arm 214 and second arm 216 may be located along a top edge thereof and may be operative to reposition reel 202. A reel tube 224 of reel 202 may be rotatably received at its opposite ends by first carrier assembly 220 and second carrier assembly 222.

FIG. 3 shows a center portion of reel 202. A first baffle 302, a second baffle 304, a third baffle 306, a fourth baffle 308, a fifth baffle 310, and a sixth baffle 312 may be connected to reel tube 224. A first plurality of tines 314, a second plurality of tines 316, a third plurality of tines 318, a fourth plurality of tines 320, a fifth plurality of tines 322, and a sixth plurality of tines 324 may be connected to first baffle 302, second baffle 304, third baffle 306, fourth baffle 308, fifth baffle 310, and sixth baffle 312, respectively. During operation, reel tube 224 may rotate at various speed (e.g., depending on the crop being harvested) and the various tines may rake grain or other materials into elevator assembly 108 of combine 100.

As described with respect to FIG. 2, reel tube 224 may be connected to header 110 via first carrier assembly 220 and second carrier assembly 222. In addition, reel tube 224 may be attached to header 110 or directly to combine 100 via a reel arm 326. Reel tube 224 may comprise a bearing 328 that may be connected to reel arm 326 via a bearing mount 330. A flexible member may be located between bearing 328 and bearing mount 330. For example, a rubber member may be located between bearing 328 and bearing mount 330. The rubber member may allow bearing 328 to semi-float.

While FIG. 3 shows reel tube 224 connected to reel arm 326 in one location (e.g., a midpoint of reel tube 224), various embodiments may have more or less reel arms. For example, reel tube 224 may be supported by three reel arms spaced evenly along reel tube 224's length.

Conventional headers over 20 feet in length comprise two or more reel sections. For example, a conventional 30 ft. header comprises two 15 ft. reel sections connected by U-joints, connecting shafts, and connection flanges. Because reel tube 224 may be a continuous piece (i.e., may not have joints), conventional pieces (e.g., U-joints and connecting shafts) may not be needed. The elimination of these additional parts may offer reductions in costs such as, for example, manufacturing costs, maintenance costs, and operational costs. For instance, reel tube 224 may be constructed as a continuous piece of any length (e.g., 30 ft., 35 ft., 40 ft. or more) and not have joints that may require connecting shafts or other joining mechanisms.

Reel tube 224 may be a solid member (i.e., have no internal voids) or reel tube 224 may comprise a hollow tube having an internal structure. The internal structure may provide an increased rigidity to reel tube 224. The increased rigidity may allow reel tube 224 to have lengths in excess of, for example, 30 ft. without the need for U-joints and connecting shafts.

Reel arm 326 may or may not provide substantial support for reel tube 224. For example, reel tube 224 may comprise an internal structure that may act to keep reel tube 224 in a substantially straight configuration. In other words, reel tube 224 may be substantially ridged enough that it may not deform (i.e., sag in the middle) to a point that operation of combine 100 may be affected.

In addition, reel arm 326 may provide substantial support for reel tube 224 such that without reel arm 326, reel tube 224 may deform to a point that operation of combine 100 may be affected. For example, reel tube 224 may have a length-to-diameter ratio that may result in reel tube 224 being flexible to the point that without support from reel arm 326, reel tube 224 may deform toward its center. This deformation may cause combine 100 to not operate correctly or may cause damage to reel 202, header 110, or combine 100 during operation.

Bearing 328 may comprise a plastic sleeve that may encircle reel tube 224. For instance, bearing 328 may comprise a thermal set (e.g., nylon) or a thermal plastic (e.g., an epoxy). For example, bearing 328 may comprise a polymer having a having a coefficient of friction less than 0.2. In addition, bearing 328 may fully encircle reel tube 224 or may partially encircle reel tube.

The above features described with respect to reel 202 may also apply to center-gathering auger 212 as well. For example, a second reel arm may be used to support for center-gathering auger 212. Center-gathering auger 212 may comprise a bearing connected to a second reel arm.

An embodiment may comprise an apparatus. The apparatus may comprise a reel comprising a bearing mount, a bearing, and a reel tube. The bearing mount may be connected to the bearing. The reel tube may comprise a midpoint. The reel tube may also be a continuous piece and may be supported proximate the midpoint by the bearing.

Another embodiment may comprise an apparatus. The apparatus may comprise a combine comprising an elevator assembly, a bearing mount, a bearing, and a reel tube. The bearing mount may be connected to the bearing. The reel tube may comprise a midpoint. The reel tube may also be a continuous piece and may be supported proximate the midpoint by the bearing.

Yet another embodiment may comprise a method. The method may comprise: supporting a reel tube about an axis of rotation, the reel tube being a continuous material; and rotating, without substantial deformation of the reel tube, the reel tube about the axis of rotation. When rotating the reel tube about the axis of rotation, the reel tube may be supported proximate a midpoint of the reel tube during the rotation.

Both the foregoing general description and the following detailed description are examples and explanatory only, and should not be considered to restrict the invention's scope, as described and claimed. Further, features and/or variations may be provided in addition to those set forth herein. For example, embodiments may be directed to various feature combinations and sub-combinations described herein.

All rights, including copyrights, in the code included herein are vested in and the property of the Applicant. The Applicant retains and reserves all rights in the code included herein, and grants permission to reproduce the material only in connection with reproduction of the granted patent and for no other purpose.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example embodiments.

What is claimed is:

1. An apparatus comprising:
a bearing mount;
a bearing connected to the bearing mount; and
a reel tube comprising a midpoint, the reel tube being a continuous piece and partially supported proximate the midpoint by the bearing.

2. The apparatus of claim 1, wherein the reel tube being the continuous piece comprises the reel tube having no joints.

3. The apparatus of claim 1, wherein the reel tube has a length of at least 35 feet.

4. The apparatus of claim 1, wherein the reel tube comprises an internal structure operative to maintain the reel tube in substantially straight.

5. The apparatus of claim 1, wherein the reel tube comprise a solid material.

6. The apparatus of claim 1, wherein the bearing comprises a plastic bearing.

7. The apparatus of claim 6, wherein the plastic bearing fully encircles the reel tube.

8. The apparatus of claim 1, further comprising a real arm operatively connected to the bearing mount.

9. The apparatus of claim 8, wherein the real arm does not substantially support to the reel tube.

10. An apparatus comprising:
a combine comprising an elevator assembly;
a bearing mount connected to the combine proximate the elevator assembly;
a bearing connected to the bearing mount; and
a reel tube located proximate the elevator assembly and comprising a midpoint, the reel tube being a continuous piece and partially supported proximate the midpoint by the bearing.

11. The apparatus of claim 10, wherein the reel tube being the continuous piece comprises the reel tube having no joints.

12. The apparatus of claim 10, wherein the reel tube has a length of at least 35 feet.

13. The apparatus of claim 10, wherein the reel tube comprises an internal structure operative to maintain the reel tube in substantially straight.

14. The apparatus of claim 10, wherein the reel tube comprise a solid material.

15. The apparatus of claim 10, wherein the bearing comprises a plastic bearing.

16. The apparatus of claim 15, wherein the plastic bearing fully encircles the reel tube.

17. The apparatus of claim 10, further comprising a real arm operatively connected to the bearing mount.

18. The apparatus of claim 17, wherein the real arm does not substantially support to the reel tube.

19. An apparatus comprising:
a combine comprising an elevator assembly;
a reel tube located proximate the elevator assembly and comprising a midpoint, the reel tube being a continuous piece having a length of at least 30 feet; and
a support arm connected to the combine, the support arm comprising:
a bearing mount located proximate the midpoint, and
a bearing encircling the reel tube, the bearing connected to the bearing mount.

20. The apparatus of claim 19, wherein the reel tube has a length of at least 40 feet.
